(19) United States
(12) Patent Application Publication
(10) Pub. No.: US 2026/0184217 A1
(43) Pub. Date: Jul. 2, 2026

(54) Portable Dual-Battery Trailer Hitch Charging System with AI-Controlled Charging for Long-Haul Trucks, RVs, Commercial, Compact EVs, and Golf Carts

(71) Applicant: Robert Lopez, New York, NY (US)

(72) Inventor: Robert Lopez, New York, NY (US)

(21) Appl. No.: 19/251,820

(22) Filed: Jun. 27, 2025

Related U.S. Application Data
(60) Provisional application No. 63/752,648, filed on Feb. 1, 2025.

(51) Int. Cl. B60L 53/62; B60L 1/00; B60L 7/10; B60L 53/14; B60L 53/302; B60L 53/51; B60L 53/53; B60L 53/57; B60L 58/12; B60R 9/05; B60R 9/058; H02J 7/14; H02J 7/35

(52) U.S. Cl. CPC B60L 53/62; B60L 1/006; B60L 7/10; B60L 53/14; B60L 53/302; B60L 53/51; B60L 53/53; B60L 53/57; B60L 58/12; B60R 9/05; B60R 9/058; H02J 7/1423; H02J 7/35; B60L 2200/22; B60L 2240/545; B60L 2240/547; B60L 2240/622

(57) ABSTRACT

Portable dual-battery trailer Al controlled charging system is disclosed for electric vehicles including long-haul trucks, RVs, compact EVs, and electric golf carts and system integrates dual battery packs, a gyro wheel, an ECVT type gearbox, and a generator/alternator for mobile energy recovery and charging and AI module and PID-based controller dynamically manages energy flow, field voltage, and battery switching using real-time driving data, and trailers have scalable battery capacity, a coiled charging cable, cooling fans, and compact rooftop storage carrier, and one trailer can be configured for 36V or 48V golf carts with low voltage recognition and top compartment for golf club storage and AI adapts to driving patterns to optimize performance and range and includes an onboard AC power panel for tools or appliances providing back up power during blackouts, off-grid energy for cabins, construction or emergency use, and a home charging port for recharging while stationary.

### CROSS-REFERENCE TO RELATED APPLICATION

This application claims the benefit of U.S. Provisional Application No. 63/752,648, filed on Feb. 1, 2025, the contents of which are incorporated herein by reference in their entirety.

### REFERENCE TO PRIOR PATENT

This non-provisional application incorporates by referencing the applicant's earlier patent application (US 2025/0038561 A1), which outlines foundational components also used in this trailer-based embodiments, such as the gyro-wheel, ECVT gearbox, BMS systems, and core energy recovery architecture.
to avoid redundancy, all prior art and relevant citations (e.g., Beshai and other patents, battery technologies, control systems) thoroughly detailed in the earlier filing are not repeated here but are acknowledged as integral references supporting the conceptual framework of this current invention.
the embodiment builds upon the prior arts disclosed in Patent No. US 2025/0038561 A1, which includes referenced citations to related technologies and its similar technical workings. Rather than restating these references in full, they are incorporated by reference in this application. A dedicated reference page will be included in this filing, listing the source patents and relevant patent numbers that provide the technical specifications applicable to this embodiment.

These referenced systems—such as the AI-controlled dual-battery configuration, gyro-wheel assistance, and the use of vehicle momentum to drive an ECVT gearbox—are foundational to both the previous and current invention. In particular, this embodiment expands upon the Al's management of field voltage to regulate generator or alternator output for charging one battery pack while the second powers the electric vehicle's motor.

This current embodiment has the exception of its unique features of a multi-purpose portable trailer based hitched Al Intelligent Controlled Power Distribution Charging System that focuses on the adaptation of the similar charging system in patent No 2025/0038561 A1 but differs in its component devices are built and installed onto a portable hitch-mounted trailer frames in different size and power versions, uniquely designed for on-the-go charging for long haul electric tractor trailers, buses, RVs, commercial, non-commercial compact EVs and a golf cart trailer charger where efficient energy management are crucial for both urban and long-haul transport enhancing both the operational efficiency and driving range by adapting or attaching one of three optional power version portable trailer hitch charging systems, and a 4th low voltage trailer charging system designed to charge battery operating electric golf carts. The four trailer charging systems will be disclosed and described in the current sections of the embodiment and completely in the Detailed Description of the Invention section.

### FIELD OF THE INVENTION

the present invention relates to the fields of Battery Management Systems (BMS), and the portable energy infrastructure, particularly in electric vehicle (EV) applications. More specifically, it pertains to a Multi-purpose, Al-managed portable trailer-based dual-battery charging system designed to extend EVs range through in-motion energy recovery with modular battery switching, and multi-environment off-grid energy support.

The invention supports long-haul electric tractor trailers, RVs, light-duty commercial vehicles, non-commercial compact EVs and electric golf carts by providing a self-sufficient power trailer capable of delivering continuous electrical power to the towing EV while in motion. It integrates a dual battery system, a gyro wheel-driven Electronically Controlled Continuously Variable Transmission (ECVT) type gear box, and a generator/alternator, managed by Al to dynamically optimize energy flow, field voltage of generator/alternator, and switching logic.

The trailer charger system functions across a wide range of EV models and brands, supporting full universal compatibility via standard charging input ports.
the charging system leverages the kinetic energy of trailer movement, as well as regenerative braking via wheel hub-mounted generators, to maintain battery charge.

Solar panels may optionally be deployed to further extend battery life while trailer charger is stationary.

The AI module adapts in real-time using vehicles momentum, GPS, torque, sensors, VCU/trailers control box, SOC data and fine-tuning the power output from the trailers generator/alternator to the trailers dual battery pack that's off the power circuit. The dual battery that is switched on in circuit is flowing energy into the towing EV's main battery pack.

A rooftop modular storage carrier adds utility with 3 trailer optional versions all with swappable battery bays providing scalability across fleet or individual applications.

In addition to EV charging, this invention includes an onboard AC output panel with pure sine wave inverter, USB ports, 120V, and 240V power sockets, enabling use as a backup power source for residential, off-grid, camping, construction purposes, or for military purposes.

All version trailer chargers may also be recharged at home using a built-in AC power cord, which combining all of these features establishes this invention as a versatile and transferable energy platform that enhances EV autonomy, supports emergency preparedness, and addresses the limitations of current charging infrastructure.

The system includes a fourth trailer charger configuration version tailored and adapted for electric golf carts operating on 36V or 48V systems, further expanding its utility into recreational, residential, and industrial environments. This low voltage trailer charger version follows the same structural and electrical build process as its 50 kWh trailer counter-part, but differs in its adjusted voltage output, scaled-down dimensions, lighter frame specifications and integrated multi-purpose rooftop storage for golf club sets, showcasing the invention's modular and scalable design.

### BACKGROUND OF INVENTION

This embodiment addresses the growing need for extended-range solutions in electric vehicles (EVs), particularly for long-haul tractor trailers, commercial, non-commercial, recreational, residential, industrial environment and off-grid scenarios.

Traditional EVs are limited by their fixed battery capacities and the current state of charging infrastructure availability, which often results in prolonged downtime, limited route flexibility, and grid congestion during peak hours, making long-distance travel difficult without extended stops for recharging. In addition to solving these issues, this invention expands its utility beyond road travel.

This multi-purpose portable dual-battery trailer charging system addresses these challenges by providing a self-contained, mobile charging mechanism that generates and distributes energy dynamically while the vehicle is in motion. The trailer charger based energy system also offers emergency and off-grid power solutions.

Existing solutions, such as supercharging stations, have addressed some of the charging time issues but finding these locations and any available has been a difficult task and super charging can accelerate battery wear and reduce overall battery life. Additionally, the energy density of current batteries and its ailments remains constrained, limiting the driving range and practicality of EVs for long-distance travel.

the suggestion of using solid state batteries see reference (16) page 33 USPTO (2010), All-Solid-State Battery (Patent No. US20100273062) for the trailer charger is a more preferred option over the lithium ion counter-part used in most EVs to power its motor and its other systems, as these older lithium ion batteries suffer from extreme cold or hot environments as described in Reference (19) page 33 USPTO Battery Thermal Management system (Patent No. 10953726B2) that requires EVs to undergo thermal management cooling due to battery packs overheating and basically cooling battery down while charging at an external charging port.

The newer advanced battery technology, the solid state batteries do not suffer from these ailments, they are built using solid electrolytes instead of liquid or gel offering faster charging, higher density and overall improved reliability and is a preferred better option. But the use of the older battery technologies will also function for this embodiment's power energy recovery bank source.

Furthermore, this invention addresses a growing concern in the recreational vehicle (RV) industry, where the shift toward electric RVs presents challenges for energy availability on extended trips. By integrating this embodiment charging solution, electric RV owners can again enjoy long-range travel, off-grid independence, and consistent battery support without relying on stationary infrastructure.

This invention provides a scalable solution that transforms the trailer charger into essential power companions for the RV industry, long-haul tractor trailers, (LDCV), and non-commercial compact EVs and the recreational community.

the trailer chargers feature make the system highly marketable not only for electric vehicle support, but also for residential, recreational, and industrial energy needs. This embodiment integrates seamlessly with its core energy recovery system to support a broader range of real-world scenarios.

For example, the built-in external AC outlet panel, see Page 5 FIG-22 which allows direct plug-in of electrical appliances, power tools, and electronic devices, enabling use of this trailer chargers feature at remote cabins, campsites, outdoor events, and remote job sites, military operations or response units without access to a power grid.

Homeowners can easily connect the trailer charger to the household circuit to temporarily power essential systems during electrical blackouts. These features make the charging system highly marketable not only for electric vehicle support, but also for residential, recreational, and industrial energy needs.

The embodiment contains several optional configurations of the systems optional power recharge source that may incorporate foldable, or externally mounted solar panels, such as 4×400-watt high-efficiency photovoltaic panels, to provide off-grid recharging capabilities when the trailer charger is stationary for extended time periods. See drawings on pages 5 FIG-20 and 6 FIG-34 that show cases visual illustration of 2 solar panels placed on the roof of trailer charger system.

The solar panels may be stored within a side-mounted bracket or a slide-out drawer within the trailers frame body as illustrated on drawing Page 5 FIG-23.

Another option as depicted in drawing page 7 FIG-7G, illustrates 2 solar panels where the bottom solar panel FIG-34b to close may swing up and the top solar panel FIG-34 to swing downward to close and lock away for storing when not in use. An integrated AC home charger permits users to conveniently recharge the trailer charger while parked at home.

In addition, the trailer charging system may optionally include wireless communication and telematics modules for remote monitoring of operational parameters see drawing Page 5 FIG-21 of the wireless communication receiver where it may be positioned and gather other data information such as battery state-of-charge (SOC), inverter load, temperature, and trailer charger location. This allows users or fleet managers to monitor the charging trailers system performance via a connected mobile app base or in-dash interface just like wireless cameras current features use, same principle of app base control.

The AI module may further support and control over-the-air (OTA) firmware updates and basic cybersecurity protocols to protect the integrity of the control logic and remote data synchronization. These features may support long-term maintainability and secure system integration.

The current embodiment also features a 4^{th} trailer charger built exclusively for electric recreational golf carts, as they become more widely used across golf courses, retirement communities, resorts, industrial parks, and campuses, there still remains a lack of mobile charging infrastructure tailored specifically to their unique voltage and size requirements. Most golf carts operate on 36V or 48V battery systems and rely on fixed charging stations, which can be limiting in remote or large-area applications.

This is why there are still 44 percent of gas powered golf carts still being used to a percentage of 56 percent of electric golf carts being used according to the United States Golf Teachers Federation article see page 34 Ref-37 (Electric Versus Gasoline Powered Golf Carts). That stated how gasoline powered carts have more range and more power to climb hilly inclines then their electric counter-part golf cart that lacks the infrastructure for electric hook-ups and battery charging equipment that today current golf cart charging solutions often require returning the golf cart to a centralized hub for recharging, leading to interruptions in operation and reducing overall convenience.

There exists a growing need for a lightweight, compact, AI-controlled trailer charging system specifically tailored for 36V and 48V electric golf carts. Such a system must be capable of delivering on the go charging with adaptive voltage recognition and regulation. Additionally, multi-functional features, such as a universal plug adapter compatible with various golf cart charger types and integrated cargo storage for golf clubs and accessories, further enhance its utility. A visual example of one potential embodiment of this trailer charger system is illustrated on Page 6, FIG-6F.

Today, there are no existing portable trailer-based EV charging systems that generate power independently while in motion. Existing portable trailers are using small-scale one solar panel units, such as those seen and deployed for roadside signage and are limited in both power generation and reliability. These units often rely on a single, low-output solar panel and lack sufficient battery storage, rendering them ineffective during extended periods of cloud cover or overnight usage. Once depleted, these systems remain offline until solar conditions improve.

In contrast, the present embodiment also integrates a multi-panel solar array, high-capacity dual battery packs, and Al-controlled power management system to ensure continuous energy availability regardless of weather conditions or time of day, dramatically increasing reliability, usability, and power output across multiple applications.

Currently mostly all trailer-mounted charging solutions rely on fossil fuels such as gasoline and diesel petroleum-based fuels to power their internal combustion engines to drive its generator/alternators or are also plugged into the utility power grid, whereas this embodiment system is a self-sustaining multi-purpose trailer charger, using motion-based energy recovery.

to enhance energy recovery, this system may optionally incorporate a regenerative braking feature as referenced in U.S. Pat. No. 10,931,165 B2 (see page 34, refer-33). During deceleration, kinetic forces acting on one set of the trailer's wheels can be harvested using integrated wheel hub generators (see drawing pages 2, 5, 6, and 7—FIG-13). The recovered energy is used to recharge the trailer's dual battery packs, thereby maximizing efficiency without requiring any modifications to the towing EVs.

The Recreational Vehicle (RV) market has traditionally relied on internal combustion engines and onboard gas and or diesel generators. As consumer and government demand shifts toward environmental safe and cleaner electric RVs, range anxiety and charging limitations have emerged as barriers to EV adoption. This invention meets the demand for a portable trailer, hitch-mounted energy system that can be quickly attached to an electric RV to supply consistent charging power throughout its long distance journeys, camping trips, or remote expeditions.

The Multi-purpose functionality, charging+power utility functions+storage space offers RV Owners tremendous value. The present embodiment addresses this need by introducing an Advanced AI-Controlled Multi-Purpose Dual-Battery portable hitched Charging System built for long distance traveling and extending Range for all electric long haul tractor trailers, commercial delivery trucks, RVs, and non-commercial EVs as well as the recreational sector that continues to face challenges related to battery capacity and charging infrastructure availability that's making long-distance traveling difficult without extended stops for recharging.

Therefore, there is a pressing need for newer technology that not only extends the driving range of all EVs but also supports a unique feature that enables EV users to quickly and efficiently attach a trailer charging system, with ultra-fast charging capability while maintaining no down time when EVs are low on battery power and extending dramatically the mileage.

### The Key Differentiators of My Invention

A. Completely Self-Sustaining-Unlike existing trailer-mounted charging units that rely on external power sources, or that are limited power wise, my charging system generates its own electricity using a gyro wheel see drawing pages 1, 2, FIG-11, an ECVT type gearbox see pages 1, 2, FIG-4, and a generator/alternator see drawing pages 1, 2, FIG-3 powered by the motion of the trailer's wheels momentum see drawing page 1 FIG-13 and FIG-14.
B. AI-Optimized Energy Management—The Al module see drawing pages 1, 2, FIG-5, dynamically controls the system's generator/alternators field voltage, battery switching, energy distribution, and regenerative power output, a feature not found in any current trailer charger solutions.
C. Dependence on Fossil Fuels-All existing mobile charger trailers operate on gasoline or diesel motors to operate the generator/alternator to convert mechanical energy into electrical energy, making them less sustainable. My invention is a fully electric see drawing pages 1, 2, 7, FIG-1 and FIG-2, and a renewable solution that aligns with the growing EV infrastructure.
D. On the Go Charging—Unlike traditional EV charging that requires stationary grid-based power supply, my charging system allows for long-haul EV tractor trailers, (LDCV), non-commercial compact EVs as well as recreational EVs to continuously generate power while driving and on the go, eliminating unnecessary stops.
E. Scalability & Multi-Industry Use—This charging system is not limited to just electric trucks. It can be adapted for fleet operations, rental services, and delivery companies and recreational providing a flexible mobile power solution for multiple industries.
F. Additionally, the trailer charger includes a detachable rooftop aerodynamic storage carrier, allowing users to carry groceries, luggage, tools or golf club sets, transforming the trailer into a Multi-purpose energy and cargo solution see drawing pages 3, 6, 7, FIG-19. This integrated storage functionality enhances usability, especially for commercial fleets, delivery companies, or local merchants that depend on its delivery service as part of their business needs, as well as its long distance delivery travel.
G. Electric RV Compatibility—A game changing solution for long-distance RV travel. The Multi-Purpose Dual-Battery Trailer Hitch Charging System is not only engineered for long-haul electric tractor trailers and commercial EVs, but also represents a breakthrough solution for the emerging electric RV industry. As shown in Drawing Page 4, FIG-4D, which illustrates an electric RV paired with its companion trailer charger, this system addresses a critical need. As traditional RVs continue transitioning to electric drivetrains, concerns over limited range and sparse charging infrastructure have become major challenges for RV owners. This invention provides an on-the-go charging solution that significantly enhances energy autonomy during long-distance travel.

This multi-purpose trailer charger offers a self-sustaining energy solution that allows electric RVs to travel extended distances without frequent stops with three optional and scalable battery configurations (50 kWh, 75 kWh, and 100 kWh) to choose from as a power source options, plus the bonus of a removable rooftop cargo carrier for gear storage. This power solution supports the nomadic lifestyle of RV users and it restores travel freedom and confidence in this electric age and ensures that EV-based RVing remains viable, efficient, and fully mobile to continue into the future.
H. The current embodiment also includes a compact trailer charging system specifically designed for electric golf carts operating on 36V or 48V battery configurations. This variation retains the AI-managed architecture and core dual-battery as illustrated in Drawing Page 7, FIG-1 and 2—while scaling it down for smaller-format electric vehicles. The system integrates automatic voltage recognition, a compact structural footprint, and a multi-purpose storage compartment for golf clubs or equipment, as shown in Drawing Page 6, FIG-37, where golf clubs are visibly stored within the compartment.
I. The trailer chargers are integrated with visual safety lighting system. This system comprises of a rear-mounted LED tail lights and side marker lights see drawings pages 2 and 5 FIG-15 that operate in coordination with the towing vehicle's lighting signals. The lighting system may be powered by the trailer's dual battery packs and managed by the AI module and an electrical harness connector attached to the pulling EVs brake lighting system to ensure consistent operation. This feature improves the trailer's visibility during low-light conditions and provides visual indicators for braking, turning, and hazard alerts, meeting highway safety compliance standards.

Incorporation by Reference: Patent No. US 2025/0038561 A1, along with its related embodiments, is hereby incorporated by reference into this application. Relevant portions of that prior disclosure have been integrated into the present invention and are cited in the Embodiments References page to avoid redundancy and maintain technical continuity across related filings. This embodiment also expands the invention's application into recreational and utility environments, further reinforcing its modular and scalable design across a broad spectrum of electric vehicle platforms.

Additional based on the results of a comprehensive patent search, no directly competing systems were identified. As such, this invention represents a novel and distinct advancement in the electric vehicle (EV) charging sector, introducing a new category of portable, Al-managed trailer-based charging systems.

### SUMMARY OF THE INVENTION

the present invention is a multi-purpose, portable, AI-controlled dual-battery trailer charging system designed to supplement and extend the driving range of electric vehicles (EVs). The system's primary components are mounted on a towable trailer frame and include two high-capacity battery packs, a gyro wheel, an electronically controlled continuously variable transmission (ECVT) gearbox, a generator/alternator, an AI control module, and additional supporting hardware. For reference, see drawing page 1, FIG-1A, which provides a schematic diagram of the component interconnections, and drawing page 2 for a visual layout depicting the physical arrangement of components.

These components operate in unison to convert kinetic energy generated during trailer motion into usable electrical energy, which is either stored in the trailer's battery packs or delivered in real time to the towing EV's main battery. The AI control module, supported by an integrated PID-based controller within the control box, dynamically manages generator/alternator field voltage, adjusts ECVT gear ratios, and handles battery pack switching. These adjustments are made based on real-time data such as vehicle speed, torque demand, battery state of charge (SOC), and GPS signals. The AI system also includes adaptive learning capabilities to refine energy optimization over time based on user driving behavior.

In addition to extending EV range, the invention offers robust multi-purpose capabilities, including:
1. Serving as a temporary backup power supply during blackouts or emergencies.
2. Providing off-grid electricity for campsites, cabins, and outdoor recreational events.
3. Acting as a mobile power station for construction sites, remote work zones, and military applications.
4. Delivering external AC power through a dedicated outlet panel for tools, appliances, and electronic devices.
5. Featuring an integrated onboard home charging interface, allowing recharge from a standard AC power outlet.
6. Incorporating regenerative braking via hub-mounted generators to capture kinetic energy during deceleration (see page 33, Ref-6, USPTO classification H02K/H02P—Dynamo-Electric Machines).
7. Including a modular rooftop storage compartment for transporting tools, equipment, luggage, or golf club sets.
8. Offering compatibility with a wide range of EV models via a universal hitch and adaptable coiled charging cable.
9. Disclosing a compact version of the system specifically designed for 36V and 48V electric golf carts, retaining the same Al-managed dual-battery architecture and energy recovery principles.

Present invention delivers a flexible, mobile energy solution that supports long-distance EV travel, off-grid applications, and emergency scenarios. It reduces dependence on public charging stations by dynamically generating and supplying power while in motion. An Al module continuously manages energy flow by monitoring load, battery status, and driving speed, with input from integrated GPS and onboard sensors.

System accommodates various EV voltage levels using a built-in step-up voltage transformer, ensuring compatibility across a wide range of electric vehicle manufacturers.

Hitch-mounted design enables fast attachment and detachment, making it adaptable to numerous EV models.

4 scalable trailer versions are proposed, each tailored to specific EV categories:
1. 50 kWh—Designed for compact or standard passenger EVs.
2. 75 kWh—Ideal for mid-sized and commercial EVs.
3. 100 kWh—Suited for electric tractor trailers, RVs, and other long-haul vehicles.
4. 36v to 48v—AI Controlled and Multi-Purpose Dual battery Trailer Charger system version built specifically for 36V/48V electric golf cart systems.

All trailer charger version is equipped with an appropriately rated generator/alternator (ranging from 25 kW to 50 kW), except the low voltage golf cart version may be reduced to a 5 Kilowatt generator/alternator and all may be modified to ensure optimal charging performance. The embodiment trailer-based charging system provides clean reliable, consistent energy for extended trips, in remote locations, and field operations. The dual-purpose design—offering both energy supply and cargo storage—adds significant utility for EV owners. Full technical details are presented in the Description of the Invention section.

Embodiment addresses the growing demand for extended-range EV support, especially in long-haul and off-grid use cases. Conventional EVs often face challenges such as limited battery capacity and inconsistent charging infrastructure—issues this solution directly mitigates.

Additional, the trailer functions as a standalone mobile power hub. The system includes a dedicated AC power distribution panel with:
1. Four 120V outlets for standard appliances or tools
2. Four 240V outlets for high-powered devices (e.g., welders, HVAC units)
3. Four USB/Type-C ports for electronics
4. Built-in surge protection and circuit safeguards

The onboard inverter can supply 10,000 watts or more of pure sine wave AC power, suitable for sensitive electronics and heavy-duty equipment. A weatherproof power activation switch enables quick and safe inverter operation.

Telematics and wireless communication modules may be included for remote monitoring of state-of-charge (SOC), internal temperature, inverter load, and GPS location—accessible through a dedicated mobile application or dashboard interface.

An optional solar charging system—such as four 400W rooftop-mounted panels—can be deployed using slide-out trays or collapsible frames (see drawing page 5, FIG-20). The modular battery bays (see drawing page 5, FIG-1 and FIG-2) support rapid pack replacement and scalability, making the system well-suited for commercial fleet applications.

Future scalability is supported via over-the-air (OTA) firmware updates and built-in cyber security protocols, enabling performance enhancements, remote diagnostics, and secure system communications.

A compact 36V/48V variant of the trailer charging system is also disclosed in this embodiment, specifically adapted for electric golf carts. This version retains the core dual-battery architecture, Al energy management, and regenerative energy recovery principles. The only modifications involve a reduced voltage range, smaller form factor, and dual-purpose storage designed for recreational applications. As such, this golf cart embodiment remains unified under the same inventive concept: a self-contained, AI-managed mobile energy platform suitable for various EV classes.

In summary, the invention introduces a scalable, portable EV charging and mobile energy delivery system capable of supporting residential, recreational, commercial, and transportation sectors—each based on the same underlying architecture and intelligent energy control methodology.

### BRIEF DESCRIPTION OF DRAWINGS

it should be understood that the drawings block diagrams, detailed descriptions, and figures provided herein are intended to illustrate and clarify the principles of the present embodiment.

these elements are included for illustrative purposes only and may be subject to modification or adaptation by those skilled in the relevant arts. It is intended that the claims herein encompass all such modifications and variations that fall within the true spirit and scope of the invention.

Disclaimer: The illustrations and technical layouts presented do not limit the scope of the invention, and the described embodiments are not intended to be exhaustive. Alternate configurations that maintain the core functionality and inventive architecture are considered within the bounds of this disclosure.

Drawing Page 1—FIG-1A: Top-Down View of Component Layout of a 2D schematic line diagram illustrating the relative placement and size of all major internal components within the trailer. The layout includes labeled interconnections between the following: gyro wheel (FIG-11), ECVT gearbox (FIG-4), generator (FIG-3), dual battery packs (FIG-1 and FIG-2), AI module (FIG-5), control box (FIG-7), step-up voltage transformer (FIG-10), battery management systems (BMS FIG-8 and BMS FIG-9), coiled charging cable (FIG-12), left trailer wheel (FIG-13), and right trailer wheel (FIG-14). The axels are located at (FIG-51), (FIG-52), (FIG-53) and two heavy duty over-running or one way clutch bearings at (FIG-54) locations. All other components are mentioned in the patent I reference by incorporation in this embodiment. The components interconnections are shown from an overhead perspective.

Drawing Page 2—FIG-2B: Component Connection Flow (Static Visual with Prior Directional Arrows) This figure presents a perspective view of the trailer's internal system with labeled components originally shown with directional arrows to indicate energy and control flow. Although now presented as a still schematic (per USPTO submission requirements), the image demonstrates how energy moves from the motion-driven gyro wheel (FIG-11) through the ECVT gearbox (FIG-4), into the generator/alternator (FIG-3), and onward to the dual battery packs (FIG-1 and FIG-2). Also shown are the AI module (FIG-5), control unit (FIG-7), BMS units (FIG-8 and FIG-9), step-up voltage transformer (FIG-10), and coiled charging cable (FIG-12). The trailers wheel hub generator (FIG-36), and depiction of the charging trailers universal cable port charger adapter plug (FIG-17), the visual safety lighting system (FIG-15) for enhanced road visibility and signaling, and Illustrating the trailer's ventilation system are two cooling fans (FIG-16) situated to blow hot air below the trailers robust frame (FIG-18). The trailer chargers basic dimensions are shown in (L, FIG-48), (W, FIG-49), (H, FIG-50). This animated layout reflects how components interconnect during operation, even though motion direction is no longer animated in the image.

Drawing Page 3—FIG-3C: Side View of Aerodynamic Trailer Charger. This figure illustrates a side profile of the streamlined trailer chargers body, showcasing the attachable Top-Level Storage Compartment (FIG-32) securely mounted to the trailer's upper enclosure frame (FIG-18). The compartment provides additional cargo utility, allowing users to store groceries, tools, or equipment during travel. The image also highlights the universal charging port (FIG-17), representing the system's ability to deliver power to the towing EV while carrying cargo simultaneously.

Drawing Page 4—FIG-4D: Side View of Electric RV with Trailer Charger System This figure presents a side view of an electric recreational vehicle (RV) Fig-CC positioned next to the Multi-Purpose Portable Dual-Battery Trailer Hitch Charger System FIG-DD. It visually demonstrates how the trailer can be easily detached from the RV. The illustration highlights the trailer's role in extending the range and energy independence of electric RVs, especially during long-distance travel or off-grid excursions.

Drawing Page 5—FIG-5E: Trailer Configuration with Enhanced Energy and Utility Features. This figure illustrates a trailer version equipped with advanced energy and utility enhancements. Key features include:
A. Trailer output port plug (FIG-17), used to connect the trailer to the towing EV's input charge port.
B. Reinforced frame structure (FIG-18) and towing arm assembly (FIG-6) for durability and safe attachment.
C. Protective weatherproof electronic panel (FIG-21) housing wireless communication and telematics modules, enabling remote monitoring and over-the-air (OTA) updates of operational parameters.
D. Regenerative braking hub generators (FIG-36) mounted on both rear wheels to capture kinetic energy during deceleration.
E. Roof top-mounted solar panels (4×400W) for off-grid recharging, with two solar panels (FIG-20) illustrating extended.
F. Solar panel support bracket (FIG-25), allowing tilting and retraction for optimal sun exposure and compact storage.
G. AC power distribution panel (FIG-22) located on the rear or side, equipped with USB ports, four 120V AC outlets, and four 240V AC outlets.
H. Slide-out modular battery bay trays (FIG-1 and FIG-2) for swappable battery packs, improving scalability and reducing downtime.
I. Slide-out modular tray for solar panel storage (FIG-23), integrated into the trailer's body for compact and secure stowage.

Drawing Page 6—FIG-6F: Golf Cart-Compatible Trailer Charger This figure illustrates the compact trailer charger designed specifically for 36V/48V electric golf carts. The image shows the trailer charger unit (FIG-31) hitched to a standard electric golf cart (FIG-30). Key features, some not fully visible in the illustration, include:
A. A scaled-down dual-battery system tailored for lower voltage golf cart platforms.
B. An aerodynamic rooftop golf club storage compartment (FIG-32), with an internal golf club holding section (FIG-37) for transporting up to four club sets.
C. A universal charging plug adapter (FIG-33) for various golf cart interfaces.
D. An optional rooftop solar panel array (FIG-34) for trickle charging, mounted with adjustable solar panel brackets (FIG-35) for tilting.
E. Wheel hub generators (FIG-36) integrated for regenerative braking and energy recovery during deceleration.

Drawing Page 7—FIG-7G: Golf Cart Trailer Charge With Foldable Solar Panel Configuration.

This figure illustrates the golf cart-compatible trailer charger equipped with foldable solar panels (FIG-34, FIG-34b), mounted to the front section of the trailer's compartment and deployed via hinged support arms (FIG-19), allowing flexible positioning. Two panels are shown in their deployed, tilted positions to optimize angled sun capture, enhancing solar charging efficiency when the trailer is parked or stationary. Positioned at the front of the trailer charger is a jockey wheel (FIG-47), used to assist with parking and maneuvering when the trailer is detached from an EV or golf cart (FIG-30). This retractable, height-adjustable wheel is mounted near the trailer hitch. It supports the trailer's tongue weight, maintains level positioning when unhitched, and ensures sufficient ground clearance during chargers usage. This configuration also shows battery packs (FIG-1 and FIG-2) located at the front of the trailer. A coiled charging cable connects to the EV's charge port (FIG-33). A power distribution panel (FIG-22), located on the side or rear of the enclosure (FIG-18), that includes USB ports and 120V AC outlets for external device connectivity. The wheel hub generator (FIG-36) recovers energy during braking, and the rooftop storage compartment (FIG-32) designed to hold golf club sets, accessories, or other cargo.

Drawing Page 8—FIG-8H: Ground-Deployed Detachable Solar Mat Configuration. This figure illustrates foldable or roll-able solar mats (FIG-34) that are detached from the trailer and deployed on the ground adjacent to the unit while stationary. The mats connect to the auxiliary charging port on the trailer's power distribution panel (FIG-22) via an input cable (FIG-54). The panel, located on the rear or side of the enclosure, includes USB ports and two 120V AC outlets. This configuration allows efficient solar charging when the trailer is parked—especially useful in golf course environments or remote outdoor areas with extended sunlight exposure. The solar mats are designed to be weather-resistant, lightweight, and portable, with integrated ground anchors or edge flaps to secure them against wind and uneven terrain.

### DESCRIPTION OF THE INVENTION

the referenced patent (US 2025/0038561 A1) shares similar technical and core components with this present embodiment. These references are cited in the appropriate reference pages, with corresponding patent numbers provided. This ensures that the current disclosure is not encumbered by details already familiar to those skilled in the relevant arts.

For clarification and ease of understanding, please note that the 2D block line schematic diagrams shown on Drawing Page 1 (FIG-1A) and Page 2 (FIG-2B) are intended to illustrate the functional relationships and energy flow between the components of the trailer charger system. While full wiring schematics are extensive and would vary depending on specific implementation scenarios, these figures provide a high-level conceptual overview. They focus on the operational design and component interaction, rather than on detailed physical connections.

Detailed description begins by outlining the three main versions of the trailer charger, followed by a fourth compact version designed for 36V/48V electric golf carts. This scaled-down variant is tailored to support residential, recreational, commercial, and transportation sectors. While there may be some overlap in Drawings Page 1 (FIG-1A), Page 2 (FIG-2B), and other diagrams, this repetition is intentional to enhance clarity and distinguish between the four versions.

Following sections provide step-by-step instructions in a clear and structured format. Key aspects are highlighted for clarity, ensuring that those skilled in the art can easily interpret and implement the present embodiment.

The detailed figures and 2D block line diagrams are presented in 8 Drawing Pages 1 through 8 (FIGS-1A through 8H) in this embodiment and will be used for the purpose of detailing and description of devices with FIG numbers to show the charging trailers build and working processes and its mechanical and device labels and locations. See drawings page 1 FIG-1A, the schematic 2D line layout for a comprehension and understanding of the devices location.

This embodiment is a multi-purpose dual battery hitch mounted trailer with advanced AI charging system that is housed in a robust utility type trailer chassis uniquely designed for attaching to the rear of any EVs chassis with a ball type hitch mechanism that secures safely to the trailers tongue coupler see drawing pages 2 and 5 (FIG-6).

The trailer charger may come in a variety of three power versions such as, 100 Kilo watts, 75 Kilo watts and a 50 kilo watts dual battery charging system. Since this invention depicts several variety models it may be modified for different electric tractor trailers, truck models, commercial applications, and non-commercial sub compact EVs as well as the community and recreational transportation sector.

For example, on a long haul electric tractor trailer and trucks, a larger more robust built trailer charging system built with the optional dual 100 kilo watts rated battery packs may be utilized and placed onto the utility trailer floor section and may be positioned as shown in drawing page 2, (FIG-1)-(FIG-2) or the batteries may be placed at another position to best balance the system. The increased rated 100 watt dual battery trailer version handles the larger EV trucks higher electrical ratings load.

The midsize commercial EV delivery trucks or other midsize compact EVs may have the optional of the middle size charger trailer version with the installed dual 75 kilo watts battery packs.

for the small and compact passenger EVs has the option to handle the smallest trailer charger version with a dual 50 kilo watts battery packs. Each trailer charger version can be adapted to handle a variable rating of 25 to 50 kilo watts generator/alternator that's depended on the trailer chargers battery wattage amount number it will be installed onto, and must be tested for optimal charging performance.

This drawing in Page 5 FIG-5E illustrates the trailer charger equipped with foldable or solid solar panels see (FIG-20), mounted to the roof top of the trailer chargers storage compartment see drawing page 3 (FIG-19) and solar panels shown deployed via hinged support arm brackets see drawing page 5 (FIG-25), allowing flexible positioning and tilted positions to optimize angled sun capture, enhancing solar charging efficiency when the trailer is parked or stationary.

The battery management system (BMS), a control box and a variable 25 to 50 kilo watt rated generator/alternator and its other device mechanisms, gyro wheel, ECVT gear box, AI module, a step-up voltage transformer all are installed onto the trailer frame see drawing page 1 (FIG-1A) showing a 2D layout of all devices in their perspective connections, placement, and dimension of layout and may also be changed by a person with the proper skill and knowledge in the relevant field of arts.

the trailers frame may vary based on specific applications and dimensions and may be adjusted accordingly by the manufacturer, but a basic estimate measurement is referenced in this embodiment and other key components for illustrative purposes and may be modified by those skilled in the relevant arts. It is intended that the claims herein encompass all such modifications that may fall within the scope of present invention: Trailers chargers frame and key component dimensions:

Trailer frame for EVs and a scaled down compatible golf cart is not shown below but may be adjusted and implemented: Since this invention can be modified for different electric truck models and commercial applications, dimensions may be adjusted accordingly.
Length: 6 to 8 feet, see drawing page 2 (FIG-48).
Width: 4 to 5 feet, see drawing page 2 (FIG-49).
Height: 3 to 4 feet, see drawing page 2 (FIG-50).

Dual Battery Packs:
Each battery pack: Approximately 3 feet long×2 feet wide×1.5 feet tall.
Battery type: Solid-state, lithium-ion or other suitable type.

Gyro Wheel System: May be adjusted in size, see drawing page 1 (FIG-11).

Diameter: Approximately 24 to 36 inches.

Weight: 150 pounds (or optimized based on application).

ECVT Gearbox: Maybe adjusted for size, see drawing page 1 (FIG-4).
Length: 18 to 24 inches.
Width: 12 to 18 inches.
Height: 10 to 15 inches.

Generator/Alternator: 50/25 Kilo watt output power see drawing page 1 (Fig-3). Size varies based on power output but typically 18 to 24 inches long.

Hitch mount Attachment: Ball Mount type and Tongue Coupler. Standard Class 3 or Class 4 trailer hitch for easy attachment to electric tractor trailers and all other EVs and golf carts.

For security purposes a heavy duty standard pin and clip to secure the EVs ball mount to the trailer chargers hitch receiver to prevent disengaging while system is in operation.

### Ventilation System

Airflow vents and cooling fans may be strategically placed for optimal heat dissipation.

See drawing page 2 showing a pair of cooling fans in the rear section of trailer charger (FIG-16). The panel specification includes:

Four 120V AC outlets for common appliances, tools, or power strips Two 240V AC outlets for higher-demand equipment such as welders or HVAC units Two USB ports for charging mobile devices or electronics

Optional circuit protection and surge suppression are integrated to safeguard connected devices. This built-in interface allows the trailer to operate as a standalone off-grid power hub, particularly valuable during power outages, emergency, disaster, construction projects, outdoor operations, or recreational travel.

In addition, the trailer system may optionally include wireless communication and telematics modules for remote monitoring of operational parameters, such as battery state-of-charge (SOC), inverter load, temperature, and trailer location. This allows users or fleet managers to monitor system performance via a connected mobile app or in-dash interface see drawing page 5 (FIG-21) showing the unit location. These features make the system highly marketable not only for electric vehicle support, but also for residential, recreational, and industrial energy needs. These systems are readily available and may be implemented on all 4 trailer chargers.

The embodiments trailer chargers contain two of equal size 480V or variable voltage Battery Packs, see drawings page 1 and 2 (FIG-1) and (FIG-2) of Solid-state or lithium-ion or of any other construction to store energy for extended range.

the diagram illustrates the functional interconnection of the components in the AI-controlled dual-battery trailer charging system. This system is orchestrated by the AI Module and the controller, which work together with other critical components to manage energy flow and optimize performance.

A Gyro Wheel System weighing approximately 150 pounds see drawing pages 1 and 2 (FIG-11), or optimized for the specific size trailer charger and its EV application type version that will assist the generator/alternator to diminish drag effect and Its connected to an ECVT (Electronic Continuously Variable Transmission) type gearbox that will provide the high speed revolution rpms to the gyro-wheel see drawings pages 1and 2 (FIG-4) of an ECVT which automatically adjusts its gear ratios through AI data to optimize torque and speed to the gyro wheel, generator/alternator and powered/driven by the rolling motion of the charging trailer's wheels/tires see drawing page 1 (FIG-13) and (FIG-14).

The Energy Recovery Mechanism: The gyro wheel's motion is transmitted via an axle that drives the generator/alternator, see drawings pages 1 and 2 (FIG-3), producing electrical current that recharges the portable trailers battery packs then forwards the energy via attached charging cable cord see drawing pages 1 and 2 (FIG-12) through the portable trailer chargers cable port plug see drawing pages 2 and 5 (FIG-17) into the EVs charging input port.

The AI Module, see drawing pages 1 and 2 (FIG-5), manages energy recovery, battery switching, and operational efficiency in real time and ensures that various EV voltage requirements are met and ensuring compatibility with all EV Manufacturers voltage and wattage requirements through the control box see drawing pages 1 and 2 (FIG-7).

The Step-Up Voltage Transformer, see drawing pages 1 and 2 (FIG-10), ensures compatibility with various EV voltage requirements by dynamically adjusting voltage output. The Al integrates with the towing vehicle's and trailer charger systems via GPS and sensors through the connected cable port from trailer charger see drawing page 2 (FIG-17) to EV to adapt dynamically to driving conditions. The system is adaptable for different EV voltage systems, with an integrated step-up voltage transformer that ensures correct output voltage.
it also includes a robust support system where the generator/alternator's axle connection extends to the trailer chargers right wheel hub with a secondary one-way clutch bearing to enhance mechanical support and durability.
the trailer charger is compact and enclosed, with two ventilation fans, see drawings page 2 (FIG-16) to prevent overheating and a universal ball and hitching mechanism see page 2 (FIG-6) for quick deployment across vehicle platforms.

A simpler and detailed technical explanation of the trailers charging system will be explained further to help individuals skilled in the relevant arts.

The Multi-purpose Portable Dual-Battery Trailer Hitch Charging System is designed as a universal power solution for long haul electric tractor trailer trucks, RVs and capable of adapting to multiple voltage and amperage requirements across different EV manufacturers and models.

### 1. AI-Controlled Voltage & Amperage Detection

The AI module continuously monitors the connected EV's battery parameters (voltage, amperage, and state of charge). Upon connection, the AI automatically detects the EV's required charging voltage and current using real-time sensor analysis and communication protocols (such as CAN bus or other EV-compatible standards). Based on this detection, the system dynamically adjusts the voltage regulator to match the required charging profile of the EV.

### 2. Dual-Battery System With DC to DC and AC to DC Inverter

The trailer charger houses two independent battery packs that function as a high-capacity power bank with its stored energy which is then transferred to the EVs main battery pack when its energy is below a low discharge status charging its battery pack via the trailer chargers universal adapter cable port to EVs input charge port.

A DC-to-DC inverter ensures that a fast energy transfer is stable and optimized for the connected EV's voltage range.
the trailer charger can charge its own batteries while simultaneously supplying power to the EV, ensuring continuous operation without downtime.

### 3. Intelligent Power Distribution

If the EV's main battery is low, the system prioritizes direct charging from the trailer's stored energy. If the trailer's battery needs replenishing, the gyro wheel and generator/alternator system regenerates power while the EV is in motion. The AI ensures seamless switching between energy sources, preventing power loss and optimizing charging cycles.

### 4. Adaptability for Different EV Models

the trailer charging system supports multiple voltage outputs, ranging from 400V to 800V DC (or customizable based on EV's requirements). Amperage levels are adjusted dynamically to meet the power needs of different EV's regardless of manufacturer make or model.

The system is compatible with various charging standards for example (CCS) Combined charging System or Universal Standard, making it adaptable for a wide range of all electric and commercial vehicles.

### 5. Automatic Voltage Regulation & Safety

Charging system features an intelligent voltage regulator readily available in the market but controlled by the AI that adjusts the required charging voltage level, ensuring safe and efficient energy transfer.

Built-in protection circuits prevent overcharging, overheating, and electrical overloads. AI continuously monitors system performance, making real-time adjustments to maintain optimal charging efficiency through the precise control of the field voltage of the generator/alternator.

Charging system functions as a universal, AI-driven high power bank for long-haul electric tractor trailers and (LDCV) and non-commercial compact EVs. Unlike traditional charging solutions that rely on grid power or fossil fuels, this trailer charger provides a unique self-sustaining energy source, adapting to multiple voltage and amperage requirements automatically. Fleet operators and businesses no longer need separate chargers for different EV models—this single system adjusts on demand.

The Build Process Referring to Drawings Pages 1—FIG-1A, Page 2—Fig-2B and referencing the Patent No. (US. 2025/0038561 A1) build process and components that are similar in parts and structure and will be used in this embodiment and to avoid build redundancy in this embodiment will reference the source patent.

the trailer chassis that supports an enclosed housing structure see drawings page 2 (FIG-2B) where the dual solid-state or lithium-ion battery packs (FIG-1, FIG-2) are positioned in the mid rear compartments, may be placed at another convenient position, and respectively.

The ECVT gearbox see drawing page 1 (FIG-4) is mounted in-line with the trailer's left wheel shaft see drawing page 1 (FIG-51) and is driven by the rotational motion of the trailer wheel (FIG-13).

The output shaft of the ECVT gearbox connects to the central shaft of the gyro wheel see drawing page 1 (FIG-52), connected to a one way clutch bearing see page 1 (FIG-54) pressed into the left side of the gyro wheels hub mid-way and structured for free motion or free rotation.

Opposite end of the gyro wheel, a direct shaft with coupling leads to the alternator/generator see drawing page 1 (FIG-3), which is positioned adjacent to the right-side of gyro wheel see page 1 (FIG-14).

A continuous shaft exiting the gyro wheel see page 1 (FIG-53) connects to the generator/alternator by the use coupling on its input shaft at generator/alternator then its shaft may continue on the opposite side of generator/alternators output shaft connecting by way of a coupling to a second heavy duty one-way clutch bearing see page 1 (Fig-54) pressed onto the trailer chargers right side wheel hub, reinforcing mechanical support and maintaining one-directional rotation.

An AI module see page 1 (FIG-1) centrally located near the control box manages the switching between battery packs, monitors voltage levels, and controls gear ratios and generator/alternators field voltage based on data received from torque, speed, and GPS sensors.

A step-up voltage transformer see page 2 (FIG-10) is installed after the generator/alternator and before the battery input bus to regulate the output voltage in accordance with the EV's requirements. All components are protected within an insulated and or ventilated housing shell see page 2 (FIG-18), with two cooling fans (FIG-16) installed for temperature regulation.

For more clarity for the usage of the extra heavy duty one way clutch bearing on the right side of trailers wheel hub it's to add enhancement, structural robustness and reliability of the charging systems mechanism. The generator/alternator, which is driven by the gyro wheel supported by an extended axle shaft connected to the left side of the generator/alternators input shaft by a coupler that rotates the center piece structure called an (armature) that extends out the opposite end of generator/alternators shaft.

This generator/alternator opposite side output shaft may connect by coupler to an axel shaft output end that's connected by way of spline into a heavy duty one way clutch bearing that been pressed onto the right trailers wheel hub. This design stabilizes and reinforces the alignment of the systems rotating shafts, providing better distribution of rotational loads and increasing the overall strength and durability of the whole charging unit. This enhancement ensures that the entire assembly, gear box, gyro-wheel to-generator/alternator unit operates as a more cohesive and mechanically secure structure during trailers motion.

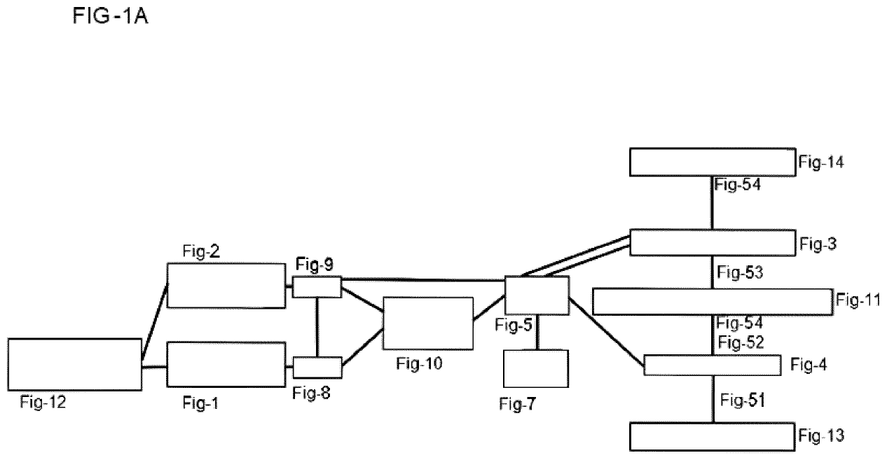

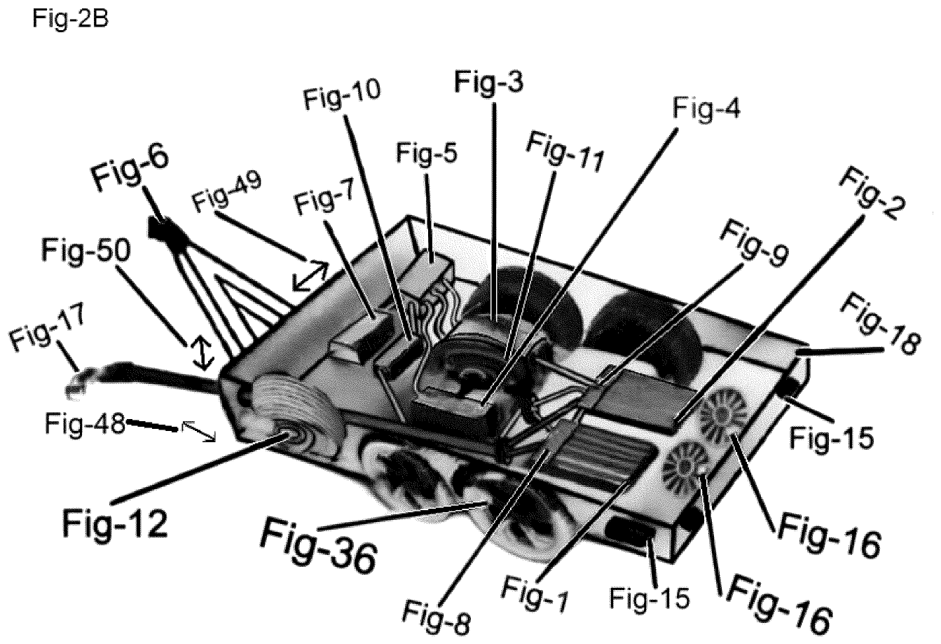

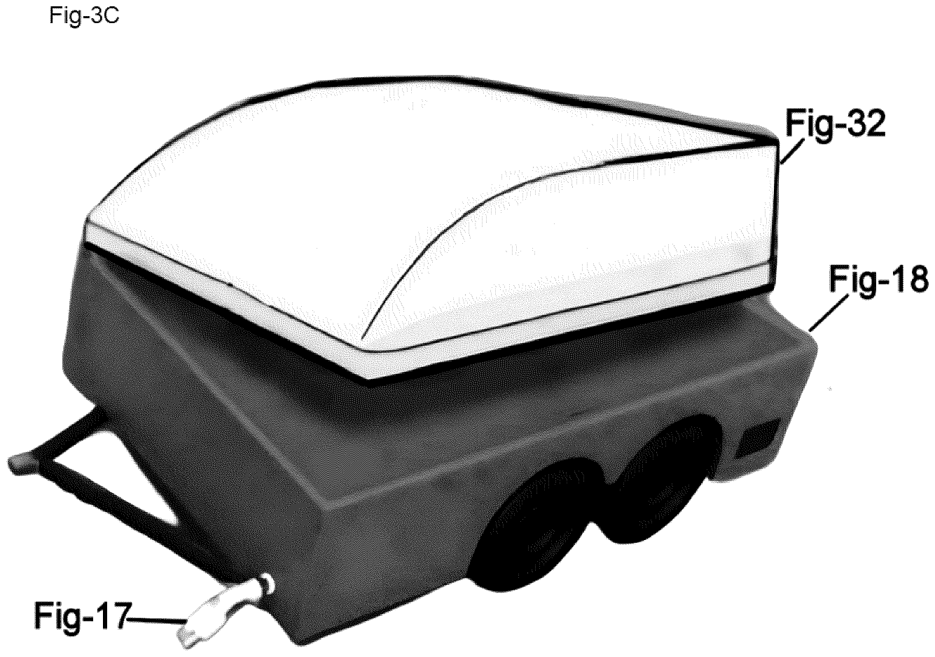

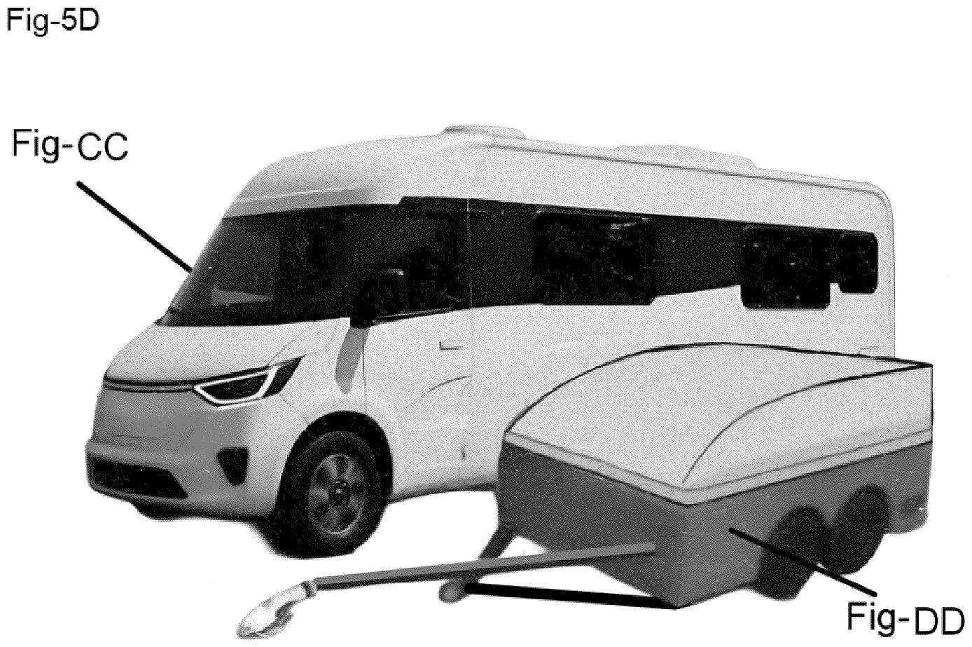

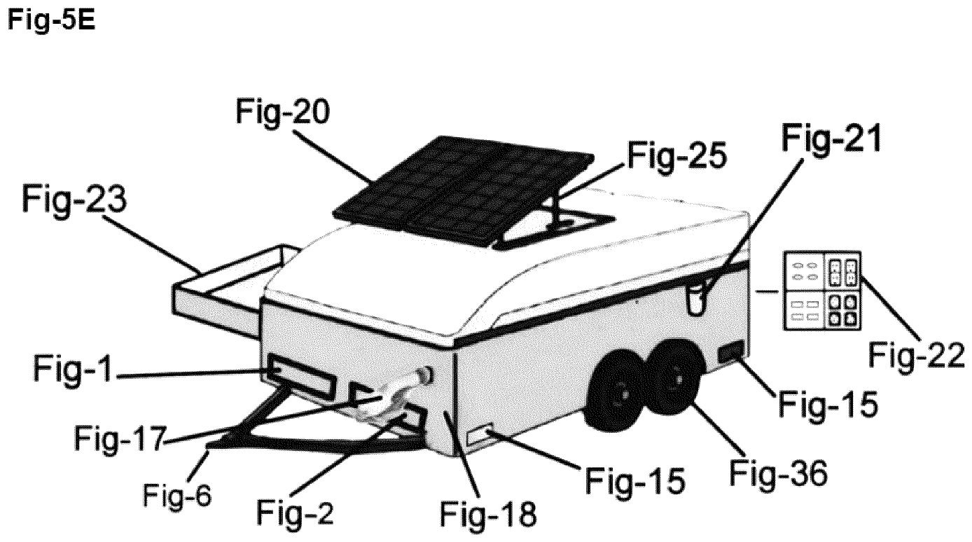

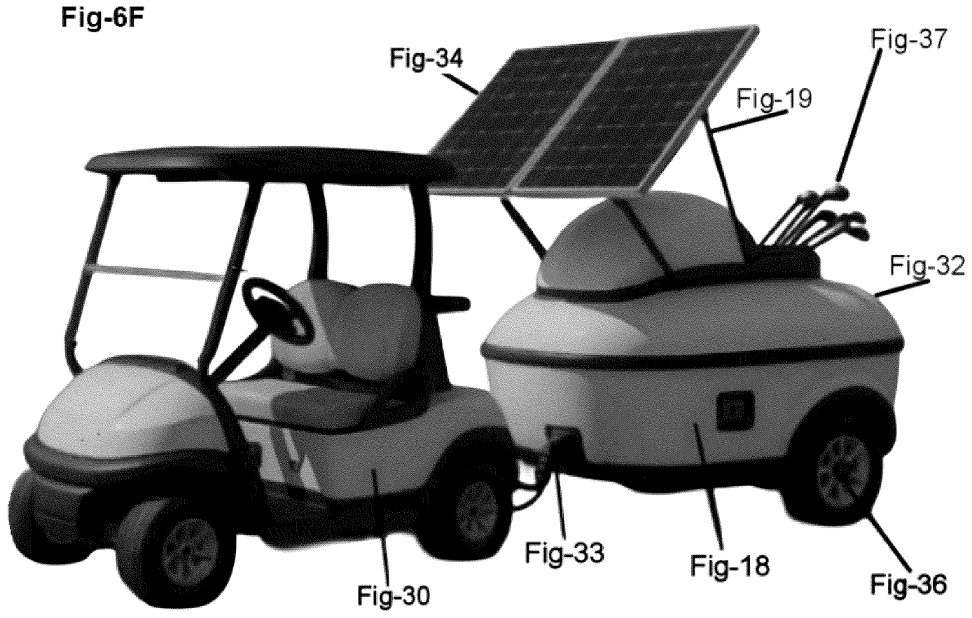

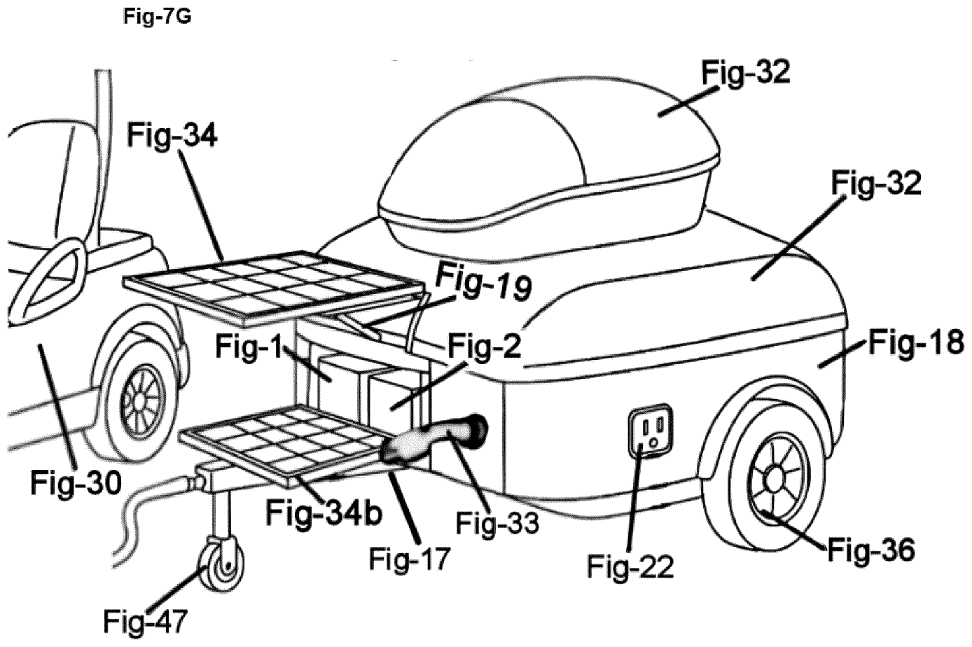

For a better understanding a highlighted explanation below of how the trailer charging system operates is basically the trailer charger contains two of equal size 480V or higher voltage Battery Packs, see drawings Page 1 FIG. 1 and FIG. 2 of Solid-state or lithium-ion construction to store energy for extended range. This diagram illustrates the functional interconnection of the components in the AI-controlled dual-battery trailer charging system.

This system is orchestrated by the Al Module and the controller, which work together with other critical components to manage energy flow and optimize performance.

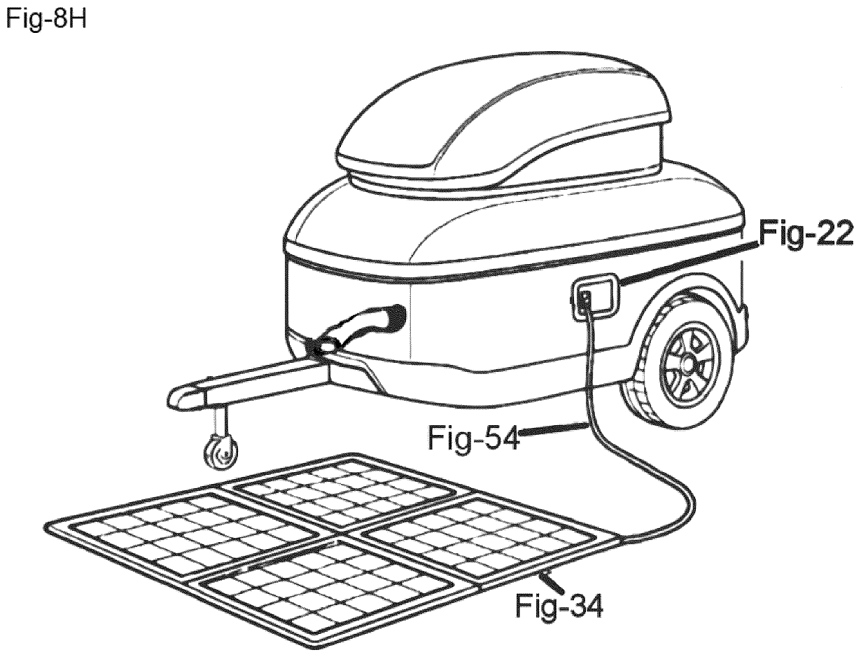

A Gyro Wheel System weighing approximately 150 pounds see drawings page 1 FIG-11, or optimized for the specific size trailer charger or its EV application is connected to an ECVT (Electronic Continuously Variable Transmission) type gearbox see drawings page 1 FIG-4 which automatically adjusts gear ratios to optimize torque and speed to the gyro wheel and powered by the rolling motion of the trailer's wheels see drawings page 1 FIG-13 and FIG. 14.

The gyro wheel's motion is transmitted via an axle that drives a generator or alternator see drawings page 1 FIG-3, producing electricity that recharges the portable trailers battery packs then forwards the energy via attached charging cable cord see drawings page 1 FIG-12 through the portable trailer chargers cable port plug see drawings page 2 FIG-17 into the EVs charging input port.

The electricity produced charges one battery pack that is off the trailers power circuit while the trailers chargers second battery provides power to the towing vehicles main battery pack or if at maximum charged status, charged trailer battery pack is held in reserve.

An optional regenerative brake generator feature may also be included, wherein deceleration forces on one set of the trailer's wheels are harvested via wheel hub generators see drawing pages 2 and 5 (FIG-13) to further recharge the trailers dual batteries. This capability maximizes energy recovery without requiring vehicle-side modifications. The Al programmed module ensures seamless operation by monitoring driving conditions and dynamically adjusting the system for efficiency.

The AI Module, see drawings page 1 FIG-5, manages energy recovery, battery switching, and operational efficiency in real time and ensures that various EV voltage requirements are met and ensuring compatibility with all EV Manufacturers voltage and wattage requirements through the control box see drawings page 1 FIG-7 also controlling the Step-Up Voltage Transformer, see drawings page 1 FIG-10, ensuring compatibility with various EV voltage requirements by dynamically adjusting voltage output. Additionally, the Al communicates with the EVs speed using GPS and other sensors and adjusts the charging system in real time. The Al integrates with the towing vehicle's systems via GPS and sensors through the connected cable port to adapt dynamically to driving conditions.

The AI controller may further support over-the-air (OTA) firmware updates and basic cybersecurity protocols to protect the integrity of control logic and remote data synchronization. These features support long-term maintainability and secure system integration. The charging trailer reduces or may eliminate the reliance on external charging stations and supports long-distance travel by dynamically generating and supplying electrical energy while in motion to the towing EVs main battery pack through the trailer chargers charging coiled cable and EV port see drawings page 2 (FIG-12)-(FIG-17), page 5 (FIG-17).

Disclaimer: The specific programming logic, AI algorithms, and OTA firmware update protocols used in this invention are proprietary and are not disclosed in this application. These elements are considered non-essential to the understanding and practice of the invention. A person skilled in the art may implement the invention using various suitable Al platforms, firmware architectures, or commercially available controllers. The novelty of this invention lies in the structural and functional integration of components, not in the specific programming code or software interfaces.

The Golf Cart Trailer Charging System Concept and build process: The charger system similar as above but tailored and scaled down for Golf Cart Compatibility for an AI Controlled and Multi-Purpose Dual battery Trailer Charger system version built specifically for 36V/48V electric golf cart systems. The image see page 6 FIG-6F shows how the golf cart trailer charger (FIG-31) is connected by a ball and hitch coupler to a standard electric golf cart shown in (FIG-30).

the golf cart trailer charger build begins with a lightweight and narrow-track trailer designed and sized proportionally for golf carts that can pull easily without affecting performance on course paths, business industries or in gated communities.

a scaled-down dual-battery designed specifically for 36V or 48V battery systems configurable for either 3× 12V or 4× 12V batteries in series. A system using standard wet cell, lithium ion or other materials are fine for trailer chargers power source see a possible location on drawing page 7 (FIG-1), (FIG-2) tailored for lower voltages golf cart platforms supporting residential, recreational, commercial, and transportation sectors.

A Sleek, aerodynamic fiberglass club compartment that may hold 4 complete golf club sets. The compartment can be made of UV and weather-resistant with locking latches composite fiberglass or any other strong light material may also be used for construction material see page 6 (FIG-32), showing the holding section for transporting up to four golf club sets, one set is shown orderly placed in compartment (FIG-37).

A 4 feet charging cable with a universal plug adapter for various golf carts and may interface by a coiled charging cable, see drawing pages 6 and 7 (FIG-33) from the trailer charger that connects to the golf carts charging port (FIG-17). The Universal plug adapters fit for all major golf cart brands (e.g., EZ-GO, Club Car, and Yamaha).

A Smart Charging that's capable of charging lead-acid or lithium-ion systems with dynamic voltage recognition via the Al module and controller. A Scaled-down AI module with PID integration like its full size version that control, voltage output to match 36V or 48V systems.

Bonus Add-Ons, such as An optional rooftop solar panel at 2×200 watts output or more array, see drawing page 6 (FIG-34) for trickle charging, mounted with adjustable solar panel brackets page (FIG-19) for tilting, or enhancing solar charging efficiency when the trailer is stationary or parked and useful in golf course environments or remote outdoor areas with extended sunlight exposure.

The use of foldable or roll-able solar mats may also be used when needed and removed from the golf trailer chargers storage bin and ground deployed adjacent to the unit while stationary see drawing page 8 (FIG-34). These solar mats are readily available in the market and are designed to be weather-resistant, lightweight, and portable, with integrated ground anchors or edge flaps to secure them against wind and uneven terrain. The power distribution panel can be oriented and placed on the side of the trailers enclosure see drawing page 6 (FIG-18) or placed anywhere its convenient where that the solar mats charging plug can connect directly to the auxiliary charging port on the trailer's power distribution panel see drawing page 8 (FIG-22) via an input cable page 8 (FIG-54).

The build process of the solar array is known of typical parts components consisting of solar panels, inverters, charge controllers, wiring and monitoring system that will be in this embodiment controlled by the trailers AI Module and control box, and the wiring connections of the solar system to the AI Module and controller is omitted from the embodiment as the wiring connection process is to extensive in nature and embodiment already depicts a visual connection in drawing page 1 FIG-1A, component layout 2D line schematic.

Disclaimer: The specific programming logic, AI algorithms for use in this invention are proprietary and are not disclosed in this application. These elements are considered non-essential to the understanding and practice of the invention. A person skilled in the art may implement the invention using various suitable AI platforms, and firmware architectures, or commercially available controllers. The novelty of this invention lies in the structural and functional integration of components, not in the specific programming code or software interfaces. The solar charging and parts are readily available in the market and can be implemented by a person with ordinary skills in the field of art.

Optional regenerative braking wheel hub generators for hilly courses or deceleration events may be implemented and integrated for energy recovery. These hub generators are being used now and are available that can be placed onto one set of the trailers wheel hubs see drawing pages 2, 5, 7 (FIG-36).

Positioned at the front of the trailer charger is a jockey wheel see drawing page 7 (FIG-47), used to assist with parking and also maneuvering when the trailer is detached from an EV or golf cart. This retractable, height-adjustable wheel is mounted near the trailer chargers hitch tongue. It supports the trailer's weight, maintains level positioning when unhitching, and when it's retracted, it ensures sufficient ground clearance during trailer chargers traveling usage.

An external power distribution panel drawing page 8 (FIG-22) with solar charger input and power outlet options (120V and USB ports) for powering small electronics while in the golf course, business or community may be implemented as mentioned above for (e.g., phone, GPS unit, speaker). This unit can be wired directly from the trailers dual batteries and or from the solar arrays controller and be controlled by the Al Module for power efficiency.

The trailer charger may be equipped with two efficient high output low wattage ventilation fans, see drawings page 2 FIG-16 to prevent generator/alternator and battery overheating and a universal hitching mechanism see drawing page 2 FIG-6 for quick deployment across vehicle platforms.

a universal ball and hitch coupling mechanism can be implemented unto all versions of the trailer chargers frame see drawing page 2 FIG-6 for quick deployment across all EV platforms. The trailers Safety Lighting Compliance and Connectivity is to improve operational safety during night or low-visibility conditions, the trailer includes a visual safety lighting system similar to those used in traditional gas or diesel-powered trailers, see drawing page 2 (FIG-15), mounted at the rear portion of the trailer enclosure.

System features rear-mounted LED tail lights and side marker lights, providing brake, turn, and hazard signal functionality. The trailer connects to the towing EV through an electrical harness connector, which interfaces with the EVs existing tail light system. This configuration ensures seamless synchronization between the trailer lights and the towing vehicle's lighting signals. Lighting system may be connected to the internal power system and managed by the AI module see drawing page 2 (FIG-5). It automatically activates when connected to the pulling EVs lightning system and during travel to alert surrounding traffic of the trailer's operating state, thereby enhancing visibility and safety. EV Owners may have a lighting wiring kit connection installed before any trailer charger is operational a compliance with highway transportation and safety regulations.

For a better understanding of the Golf Carts Trailer Charging System, it's a scaled down charger version that's configured for use with smaller electric vehicles, such as 36V, 48V golf or other electric low voltage carts. This scaled down charger version uses dual battery packs adapted to operate with either 3×12V or 4×12V battery arrangements, supporting both lead-acid, lithium-ion or other chemistries.

The AI module and controller automatically detect the cart's type of battery installed and voltage and adjust the charging parameters in real time.

This compact trailer includes a scaled down streamlined, lightweight chassis that can be towed by golf carts or other carts without impeding performance on turf or in gated communities.

A rooftop fiberglass compartment allows secure storage of up to four full golf club sets and may include weather-resistant materials and locking mechanisms. Optional features may include energy regenerative braking recovery system, foldable 200W or more solar panels for passive charging, rear LED safety lights, and external 120V standard Outlets with USB receptacles port panel for auxiliary devices.

The Highlights of the Main Key Features:
1. The Mobile Energy Recovery and Distribution: The trailer chargers rolling wheels drive the ECVT gearbox, which rotates the gyro wheel. The gyro wheel transmits motion to generator/alternator to produce electricity. This energy is used to recharge one of the trailer's battery packs while the other battery pack is supplementing power to the towing EVs main battery pack.
2. AI-Optimized Power Management:

The AI module monitors and adjusts the system in real time, controlling: Gear ratios of the ECVT gearbox, the Field current to the Alternator/Generator for optimal energy production. Battery switching between packs to maintain a state of charge (SOC) at 100% for continuous operation.

### 3. Compact & Portable Design With Seamless Integration

The Multi-Purpose AI-Controlled Dual battery trailer charger system connects seamlessly to the towing vehicle's electrical system regardless of manufacturer or model, providing continuous power to the drive motor and maintaining battery readiness.

Trailer charger system moves easily from one EV to another EV when fast and efficient power supply is needed in emergency or on the fly situations. The trailer includes ventilation for heat management with dual Fans to dissipate heat as needed, and is designed for quick hitching and unhitching, again allowing flexible deployment across various EV platforms on the fly.

### Conclusion

This multi-purpose portable dual-battery trailer charging system provides an innovative solution for extending the range of electric long-haul tractor trailers and LDCV as well as recreational RVs and other small and midsized compact EVs, reducing dependency on external charging infrastructure and enabling efficient, uninterrupted travel. By leveraging AI-driven power management, energy recovery through mechanical motion, and a modular trailer designed with an Integrated Storage Carrier to enhance the practicality and appeal of the Portable Dual-Battery Trailer Hitch Charging System. This system can revolutionize EV efficiency for long-haul commercial transport. This embodiment demonstrates the system's modular adaptability across EV class that expands the patent's application into the recreational and light-utility electric transportation markets.

### CITED REFERENCES

The following references support the cited technologies, devices, and components integrated into this embodiment and were previously consolidated and cited in U.S. Patent Application No. 2025/0038561 A1 and are reiterated here for examiner clarity and continuity.
1. US Patent No. 20120195085—Fast Switching for Power Inverter
2. US Patent No. 20100019722—Self-Charging (SC-EV)
3. US Patent No. 20140178722—Battery Mounting and Cooling System
4. US Patent No. 20130066506—Dual Mode Range Extended Electric Vehicle
5. US Patent No. 20150155112—Electro Magnet Switch with Damping Interface
6. USPTO Classification: Dynamo-Electric Machines H02K/H02P
7. US Patent No. 20120041627—Dual Source Battery Pack System
8. US Patent No. 20130181511—Electric Vehicle Extended Range Hybrid Battery Pack System
9. US Patent No. 20150306974—Charging Station Providing Thermal Conditioning
10. US Patent No. 20190108958—Electromagnetic Switch with Stable Moveable Contact
11. U.S. Pat. No. 9,797,930—Voltage Sensor Device
12. US Patent No. 10661805B2—Vehicle Control Unit (VCU) And Operating Method
13. US Patent No. 11752894B2—Jump Starters
14. US Patent No. 20230216326A1—Dual Battery Charging Method
15. US Patent No. 20240094790—Battery Management System
16. US Patent No. 20100273062—All-Solid-State Battery
17. US Patent No. 20240253522—Dual-Battery Charging System
18. US Patent No. 11884168B2—Rapid Charging Using Shared Power Electronics
19. US Patent No. 10953726B2—Battery Thermal Management
20. US Patent No. 11766951B2—Vehicle Energy Management System
21. US Patent No. 11860130B2—Systems for Health Monitoring of Storage Devices
22. US Patent No. 11865941B2—Battery Management System
23. US Patent No. 20230134140A1-Backup Vehicle Battery
24. US Patent No. 20230138183A1—Charging Device and Control Method
25. U.S. Pat. No. 20160322859A1—Power Storage Method
26. US Patent No. 76,752,61B2—Auxiliary Battery System
27. US Patent No. 20140253045A1—Battery Control Method
28. US Patent No. 93,501,86B2—Battery Pack
29. U.S. Pat. No. 4,589,303—CVT with Synchronous Shift
30. U.S. Pat. No. 7,095,308—Step-Up Transformer
31. U.S. Pat. No. 3,307,412—North-Seeking Gyro System
32. US Patent No. 8409040B1—Hybrid Powertrain with Gear Sets
33. US Patent No. 10931165B2—Wheel Driven Generator Vehicle
34. US Patent No. 4903192A—PID Controller System
35. US Patent No. 3287649A—Audio Signal Pattern Device (Machine Learning AI Model)
36. US Patent No. 2025/0038561A1—Dual Battery Charging System with AI-Controlled ECVT and Gyro Wheel (Applicant's prior filing).
37. https://www.usgtf.com/electric-versus-gasoline-powered-golf-carts/. As noted by the U.S. Golf Teachers Federation (USGTF) article, \“Electric Versus Gasoline-Powered Golf Carts\” (2014), gas carts offer specific advantage, while electric models are known for specific advantage, demonstrating the trade-offs in the existing market.

1. A portable dual-battery charging system for electric vehicles, comprising a trailer housing two battery packs, a gyro wheel, an ECVT gearbox, an alternator/generator, and a step-up voltage transformer, wherein an AI module is configured to manage energy recovery and battery switching, and sensors are integrated to monitor torque, speed, and load, providing data to the AI module.

2. The system of claim 1, wherein the trailer is designed to connect to the towing vehicle's electrical system for supplemental power.

3. The system of claim 1, wherein the gyro wheel and ECVT gearbox optimize torque and speed to maximize energy recovery during motion.

4. The system of claim 1, wherein the Al module adjusts the ECVT gear ratios and alternator/generator field current dynamically based on driving conditions.

5. The system of claim 1, wherein the step-up voltage transformer ensures compatibility with multiple EV voltage requirements by converting the trailer's output voltage to match the charging needs of the connected vehicle.

6. The system of claim 1, wherein the trailer includes an enclosed design with ventilation for heat dissipation.

7. The system of claim 1, wherein the trailer is equipped with a hitch mechanism for easy attachment and detachment from the towing vehicle.

8. The system of claim 1, wherein the AI module communicates with the towing vehicle's GPS system to optimize energy distribution and recovery.

9. The system of claim 1, wherein the battery packs are configured for automatic switching between charging and power supply modes.

10. The system of claim 1, wherein the alternator/generator supplies power to both the trailer's battery packs and the towing vehicle's battery system.

11. The system of claim 1, wherein the trailer includes safety mechanisms such as overcurrent protection, thermal management, and automatic shutoff in case of electrical anomalies.

12. The system of claim 1, wherein the alternator/generator is additionally supported by a continuous axle shaft connected through to the trailer's right wheel hub, which is fitted with a one-way sprag clutch bearing for enhanced mechanical support and rotational integrity.

13. The system of claim 1, further comprising a detachable rooftop storage carrier mounted above the trailer's housing, designed for carrying groceries, tools, luggage, or other cargo during travel.

14. The system of claim 13, wherein the rooftop storage carrier is constructed from lightweight, aerodynamic composite material and is secured using bolt-fastened brackets or locking latches.

15. The system of claim 13, wherein the rooftop storage carrier enhances the trailer's dual functionality by providing both electric vehicle charging and cargo transportation capabilities in one unit.

16. The system of claim 1, wherein the trailer charging system is offered in three distinct configurations, comprising: (a) a 50 kWh dual battery version, (b) a 75 kWh dual battery version, and (c) a 100 kWh dual battery version, each paired with a corresponding generator/alternator unit rated between 25 KW and 50 kW.

17. The system of claim 16, wherein each trailer configuration is designed to match the energy demands of a specific class of electric vehicle, including passenger EVs, medium-duty commercial EVs, and heavy-duty electric trucks.

18. The system of claim 16, wherein the modular design of the trailer enables standardized components to be scaled across the three configurations to optimize cost and manufacturing efficiency.

19. The system of claim 1, wherein the trailer charging system is adapted for use with electric recreational vehicles (RVs), providing mobile power support for both propulsion and auxiliary onboard systems during long-distance travel.

20. The system of claim 1, further comprising an onboard AC power distribution panel integrated into the trailer, wherein the panel is configured to supply electrical power to external devices via a 10,000-watt pure sine wave inverter.

21. The system of claim 20, wherein the AC power distribution panel comprises four 120V AC outlets, two 240V AC outlets, and two USB ports, all activated via a weatherproof switch mounted on the trailer's housing.

22. The system of claim 21, wherein the panel includes built-in circuit protection and surge suppression to protect connected appliances and tools from electrical anomalies.

23. The system of claim 1, further comprising wireless telematics functionality configured to transmit real-time data including battery state-of-charge (SOC), inverter load, internal temperature, and trailer location to a mobile application or vehicle dashboard interface.

24. The system of claim 1, further comprising one or more rooftop-mounted or foldable solar panel arrays rated up to 1600 watts total capacity, configured to recharge the trailer's battery packs when stationary.

25. The system of claim 1, wherein the battery packs are housed in modular swappable bays allowing for rapid replacement or upgrade without requiring disassembly of the trailer chassis.

26. The system of claim 1, wherein the AI control module supports over-the-air firmware updates and includes integrated cybersecurity protocols for secure data communication and remote diagnostics.

27. The system of claim 1, further comprising a regenerative braking system wherein dual wheel hub generators are configured to convert kinetic braking energy into electrical power and the AI module dynamically regulates their field voltage based on deceleration/acceleration conditions to optimize energy recovery.

28. The system of claim 1, wherein the trailer is configured to supply charging power to electric golf carts operating on 36V or 48V battery systems, and the Al module includes a voltage recognition feature to automatically adjust output to match the connected golf cart's battery configuration.

29. The system of claim 28, further comprising a compact trailer chassis scaled to golf cart dimensions, and a dual-purpose aerodynamic rooftop compartment configured to securely and store up to four golf club sets.

30. The system of claim 28, wherein the trailer includes optional regenerative braking functionality, configured to recover energy during golf cart deceleration and route it to the trailer's battery packs under control of the AI module.

31. The system of claim 28, further comprising one or more rooftop-mounted or foldable solar panels configured to provide continuous trickle charging to the trailer's battery packs when the trailer is idle or disconnected from the golf cart, wherein the AI module regulates solar input to maintain optimal battery health.

32. The system of claim 28, wherein the trailer includes an AI-controlled universal plug adapter configured to support interchangeable connections with one or more of the following golf cart charging interfaces: Crowfoot-style, D-style, RXV, G29, and 3-pin round plugs.
